(19) United States
(12) Patent Application Publication
(10) Pub. No.: US 2008/0092687 A1
(43) Pub. Date: Apr. 24, 2008

(54) Shift-Assisting Device for a Manual Transmission

(76) Inventors: Josef Bader, Friedrichshafen (DE); Stefan Renner, Bodman-Ludwigshafen (DE)

Correspondence Address: DAVIS BUJOLD & Daniels, P.L.L.C., 112 PLEASANT STREET, CONCORD, NH, 03301, US

(21) Appl. No.: 11/720,016

(22) PCT Filed: Nov. 19, 2005
(86) PCT No.: PCT/EP05/12410

§ 371 Date: May 23, 2007

(30) Foreign Application Priority Data
Nov. 24, 2004 (DE) 10 2004 056 609.7

(51) Int. Cl. F16H 61/30

(52) U.S. Cl. 74/473.11; 74/473.12

(57) ABSTRACT

A shift-assist device for a manually shiftable manual transmission by which the gear shift shaft or a shift fork of the shifting apparatus of the transmission is axially movable to assist shifting. The gear shift shaft (16) or the shift fork (19) of the shift facility of the transmission can be moved axially for shifting the selected gear as a function of force exerted by the driver on the shift lever (18).

This is a national stage completion of PCT/EP2005/012410 filed Nov. 19, 2005 which claims priority from German Application Serial No. 10 2004 056 609.7 filed Nov. 24, 2004.

### FIELD OF THE INVENTION

The present invention concerns a shift-assisting device for a manually shiftable manual transmission.

### BACKGROUND OF THE INVENTION

Automated manual transmissions are known from the state of the art which correspond to manually shiftable manual transmissions in regard to their main components in which the shifting clutch as well as the selection and shifting process for the individual gears takes place using pneumatically or hydraulically activatable actuators. In this connection, the gear shift shaft is rotated using a selection actuator for path selection and moved axially through a shifting actuator for shifting.

Usually the pneumatic piston is attached to the cantilever arm in transmissions of this type and arranged parallel to the flow of the shifting force, whereby the activation by a trailed valve is executed in the piston as a function of the shifting force.

A pressure-regulating device for an activation apparatus preferably constructed as a piston-cylinder arrangement in a transmission of this type is known, for example, in the framework of German Patent DE 102 49 341 by the applicant. It includes a pressure-generating device, a main cylinder regulating facility with corresponding control pressure lines, a sensor for ascertaining the pressure in a control pressure line, at lest one pressure-controlled actuator, shift valves for connecting the control pressure lines to feeder lines to pressure chambers of the activation apparatus and a pressure regulation apparatus for adapting the pressure level of the main pressure line to the control pressure level for the activation apparatus. Here the pressure regulation apparatus is constructed as a timed electromagnetic shift valve. The piston-cylinder arrangement is connected to the gearshift shaft of the transmission so that the latter is axially moveable for executing a gear selection.

To assist shifting pneumatically an apparatus is known in connection with manually shiftable manual transmission, whereby a constant force is exerted for shifting or for axially moving the gear shift shaft by a piston-cylinder arrangement. The supporting apparatus is activated when the shifting linkage covers a specified path against the force of a spring.

### SUMMARY OF THE INVENTION

The present invention is based upon the objective of indicating a shift-assisting device for a manually shiftable manual transmission in which activation of a shift by the driver is assisted by a suitable apparatus as a function of driver wishes. In this connection, as many components as possible of the shifting automation of an automatic manual transmission should be used for cost reduction.

Accordingly, a shift-assisting device for a manually shiftable manual transmission is proposed which moves the gear shift shaft or a shift fork of the shifting device of the transmission, axially for shifting the selected gear.

In accordance with the invention, a force sensor is provided in the flow of force of the manual shifting components, for example on the shift lever, whose signals are evaluated by an electronic control unit in order subsequently to control a piston-cylinder arrangement, which can be activated by valves, which stands in operative connection with the gear shift shaft or a shift fork for its axial motion. In accordance with the invention, the activation pressure of the piston-cylinder arrangement is dependent upon the force exerted on the shift lever by the driver.

In this connection, at least one pressure-regulating valve is actuated by an electronic control unit in a first embodiment of the invention, which preferably actuates as shift valves, constructed as magnetic valves, for activating the cylinder-piston arrangement. The cylinder-piston arrangement can be constructed capable of being activated pneumatically or hydraulically.

A further embodiment of the invention provides that the functionality of the shift valves is incorporated into at least one pressure-regulating valve so that preferably two pressure-regulating valves, directly connected with the cylinder-piston arrangement for shift support, are provided and are respectively connected with one side of the cylinder-piston arrangement, whereby the separate shift valves are dispensed with.

Through evaluation of the force signal in the electronic control unit, the pressure to be adjusted in the servo-cylinder or in the cylinder-piston arrangement is adapted to driver wishes. Advantageously, each desired level of force can be set, whereby harmful force increases are prevented.

Furthermore, components advantageously already present in automated manual transmissions, such as, for example, the cylinder-piston arrangement, the pressure sensors and the pressure-regulating and shift valves can be used.

### BRIEF DESCRIPTION OF THE DRAWINGS

The invention will be explained in greater detail below on the basis of the appended figures, wherein:

FIG. 1 is a schematic representation of components of a first preferred embodiment of the shift-assisting device of the invention for a manually shiftable manual transmission and

FIG. 2 is a schematic representation of components of a second preferred embodiment of the shift-assisting device of the invention.

### DETAILED DESCRIPTION OF THE INVENTION

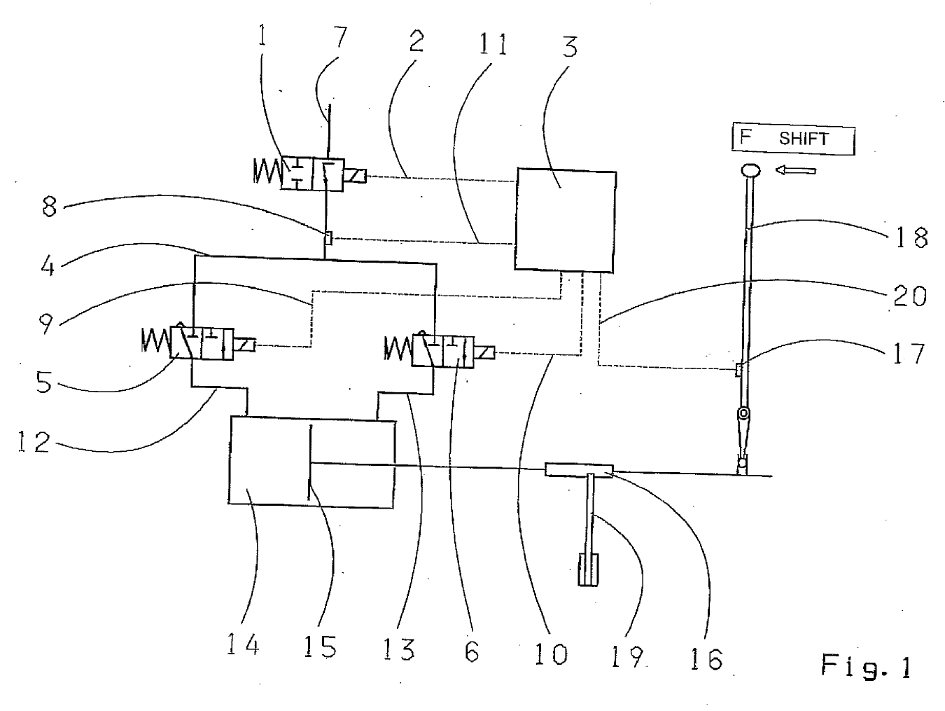

In accordance with FIG. 1, the shift-assisting device of the invention includes a pressure-regulating valve 1 which is preferably constructed as a pulsed electromagnetic valve which is connected with an electronic control unit 3, via a control line 2. The pressure-regulating valve 1 is connected through a control pressure line 4 with two shift valves 5 or 6 preferably constructed as magnetic valves. A connection between the main pressure line 7 connected with a pressure reservoir (not represented) and the control pressure line 4 can be produced or interrupted through pressure-regulating valve 1. The electronic control unit can be constructed as a separate component here. It is also possible that the shift-assisting device is controlled by the transmission control unit or an overriding control unit.

Furthermore the shift valves 5, 6 are connected with the electronic control unit 3 through control lines 9 or 10. As can be gathered from FIG. 1, a pressure sensor 8 is arranged behind the pressure-regulating valve 1 in the control pressure line 4 for recording the pressure prevailing in the control pressure line. The signals of the pressure sensor 8 are conducted through a control line 11 to the electronic control unit 3 and evaluated there such that the desired pressure can be set in the pressure control line 4 by activating the pressure-regulating valve 1.

The shift valves 5, 6 are connected with feeders 12 or 13 with the cylinder-piston arrangement 14 so that by activating the shift valves 5, 6 with the electronic control unit 3, the piston 15 can be moved axially in the desired direction to axially move the gear shift shaft 16, connected with the piston or the shift fork 19 for the purpose of shifting.

In accordance with the invention, the activation pressure of the cylinder-piston arrangement 14 is dependent upon the force F_shift exerted by the driver on the shift lever. For this purpose, a force sensor 17 is provided in the flow of force of the manual shift components, preferably on the shift lever 18, whose signals are forwarded over a control line 20 to the electronic control unit 3, whereby after the evaluation of the signals of the force sensor 17 has taken place in the electronic control unit 3, the pressure-regulating valve 1 is controlled to adjust the control pressure in the control pressure line 4 such that the control pressure and consequently the pressure upon activation of the cylinder-piston arrangement 14 for moving the interrupter shaft 16 or the shift fork 19 corresponds to the driver's wishes or is proportional to the force exerted by the driver on the shifting fork, or is set in accordance with a characteristic curve filed in the electronic control unit.

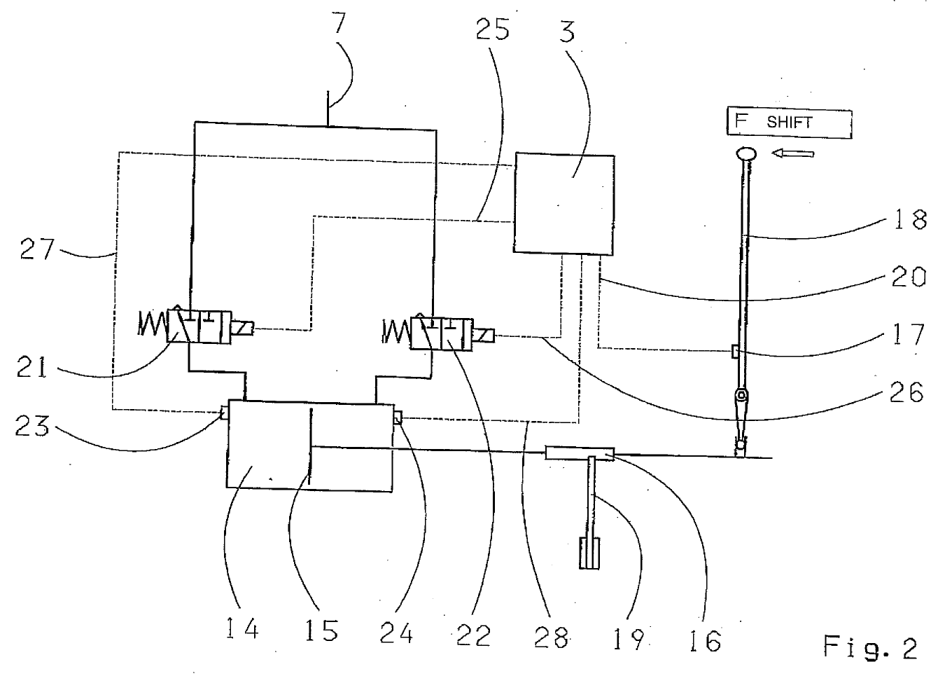

A further embodiment of the shift-assisting device of the invention is represented in FIG. 2. The difference from the embodiment according to FIG. 1 consists in that two pressure-regulating valves 21 or 22 as well as two pressure sensors 23 or 24 are provided between the pressure-regulating valve 21, 22 and the cylinder-piston arrangement 14, whereby the shift valves are dispensed with since activation of the cylinder-piston arrangement 14 occurs directly through the pressure-regulating valves 21 or 22, which in this case also serve as shift valves. In this connection, the pressure-regulating valves 21, 22 as well as the pressure sensors 23, 24 are connected with to the electronic control unit 3, via control lines 25, 26, 27 or 28.

Of course any constructional formation, in particular any spatial arrangement of the components of the shift-assisting device of the invention inherently as well as in relation to one another and to the extent that it is technically appropriate also falls under the scope of protection of the present claims without influencing the function of the shift-assisting device as it is indicated in the claims even if these formations are not explicitly represented in the figures or in the description.

### Reference Numbers

1 Pressure-regulating valve

2 Control line

3 Electronic control unit

4 Control pressure line

5 Shift valve

6 Shift valve

7 Main pressure line

8 Pressure sensor

9 Control line

10 Control line

11 Control line

12 Feeder line

13 Feeder line

14 Cylinder-piston arrangement

15 Piston

16 Gear shift shaft

17 Force sensor

18 Shift lever

19 Shift fork

20 Control line

21 Pressure-regulating valve

22 Pressure-regulating valve

23 Pressure sensor

24 Pressure sensor

25 Control line

26 Control line

27 Control line

28 Control line

1-8. (canceled)

9. A shift-assisting device for a manually shiftable manual transmission, by which one of a gear shift shaft and a shift fork of a transmission shift-assisting device is axially movable for shift assistance, the device comprising:
a cylinder-piston arrangement activatable by valves and operatively connectable with the one of the gear shift shaft and the shift fork in relation to the axial motion, the cylinder-piston arrangement (14) axially moving one of the gear shift shaft (16) and the shift fork (19) as a function of a force exerted for shifting a selected gear, and activation pressure of the cylinder-piston arrangement (14) is dependent upon the force exerted by a driver on a shift lever (18),
a force sensor (17) is provided in a flow of force of manual shift components of the transmission to sense signals of the manual shift components,
an electronic control unit (3) evaluates the signals to control activation of the cylinder-piston arrangement (14) as a function of the force exerted by the driver on the shift lever (18), a connection is made, via a control pressure line (4), between a pressure-regulating valve (1) and at least one shift valve (5, 6), which are connected to the electronic control unit (3), via at least one control line (9, 10), and a connection between a main pressure line (7), communicating with a pressure reservoir, via the pressure-regulating valve (1), and the control pressure line (4) is one of produced and interrupted, a pressure sensor (8) for recording a pressure prevailing in the control pressure line (4) is arranged behind the pressure-regulating valve (1) in the control pressure line (4) such that signals are conducted through a control line (11) to the electronic control unit (3) to be evaluated, such that a desired pressure is set in the control pressure line (4) by activation of the pressure-regulating valve (1) using the at least one control line (9), and the at least one shift valve (5, 6) are connected with the cylinder-piston arrangement (14) by at least one feeder line (12, 13), such that activating the at least one shift valve (5, 6) through the electronic control unit (3) a piston (15) of the cylinder-piston arrangement (14) is axially moved in a desired direction.

10. The shift-assisting device for a manually shiftable manual transmission according to claim 9, wherein the at least one shift valve (5, 6) is a magnetic valve.

11. The shift-assisting device for a manually shiftable manual transmission according to claim 9, wherein the device includes two pressure-regulating valves (21, 22) and two pressure sensors (23, 24) arranged between the two pressure-regulating valves (21, 22) and the cylinder-piston arrangement (14), the cylinder-piston arrangement (14) is activated directly through the two pressure-regulating valves (21, 22), the two pressure-regulating valves (21, 22) and the two pressure sensors (23, 24) are connected, via control lines (25, 26, 27, 28), to the electronic control unit (3).

12. The shift-assisting device for the manually shiftable manual transmission according to claim 11, wherein the two pressure-regulating valves (21, 22) are pulsed electromagnetic valves.

13. The shift-assisting device for a manually shiftable manual transmission to claim 9, wherein activation pressure of the cylinder-piston arrangement (14) is one of proportional to the force exerted by the driver on the shift lever (18) and adjustable according to a characteristic curve deposited in the electronic control unit (3).

14. The shift-assisting device for a manually shiftable manual transmission according to claim 9, wherein device comprising two pressure-regulating valves (21,22) and two pressure sensors (23, 24) located between the two pressure-regulating valves (21, 22) and the cylinder-piston arrangement (14), the cylinder-piston arrangement (14) is activated directly through the two pressure-regulating valves (21, 22) and the pressure-regulating valves (21, 22) and the two pressure sensors (23, 24) are connected via control lines (25, 26, 27, 28) with the electronic control unit (3).

15. The shift-assisting device for a manually shiftable manual transmission according to claim 9, wherein the pressure-regulating valves (1, 21, 22) are pulsed electromagnetic valves.

16. The shift-assisting device for a manually shiftable manual transmission according to claim 9, wherein the activation pressure of the cylinder-piston arrangement (14) is one of proportional to the force exerted by the driver on the shift lever (18) and adjustable according to a characteristic curve located in the electronic control unit (3).

17. A shift-assisting device for a manually shiftable manual transmission, the device comprising:
a cylinder-piston arrangement (14) operatively coupled to at least one of a gear shift shaft (16) and a shift fork (19) for transferring axial motion thereto;
a shift lever (18) having a force sensor (17) for detecting a force exerted on the shift lever (18) by a driver;
a first shift valve (5) and a second shift valve (6), each respectively coupled to the cylinder-piston arrangement (14) by a first feeder line (12) and a second feeder line (13);
a pressure-regulating valve (1) is coupled to the first shift valve (5) and the second shift valve (6) by a control pressure line (4) and a pressure source by a main pressure line (7), the control pressure line (4) has a pressure sensor (8) for detecting pressure within the control pressure line (4);
an electronic control unit (3) communicating, via a first control line (20), with the force sensor (17) to evaluate the signals of the force exerted by the driver on the shift lever (18),
the electronic control unit (3) communicating, via the second control line (11), with the pressure sensor (8) to register the pressure of the control pressure line (4);
the electronic control unit (3) communicating with the first shift valve (5), via, the third control line (9), the second shift valve (6), via the fourth control line (10) and the pressure-regulating valve (1), via a fifth control line (2)
the electronic control unit (3) controllably adjusting each of the first shift valve (5), the second shift valve (6) and the pressure-regulating valve (1) depending on the force exerted by the driver on the shift lever (18) and the pressure of the control pressure line (4) to adjust pressure within the cylinder-piston arrangement (14) to control axial motion of the at least one of a gear shift shaft (16) and a shift fork (19) to assist in shifting the manually shiftable manual transmission.
